(19) United States
(12) Patent Application Publication
(10) Pub. No.: US 2003/0149660 A1
(43) Pub. Date: Aug. 7, 2003

(54) Method and system for managing employee access to payroll information

(75) Inventor: James W. Canfield, St Louis, MO (US)

Correspondence Address: BRYAN CAVE LLP, One Metropolitan Square, Suite 3600, 211 North Broadway, St. Louis, MO, 63102-2750, US

(73) Assignee: TALX Corporation, St. Louis, MO

(21) Appl. No.: 10/068,061

(22) Filed: Feb. 5, 2002

(51) Int. Cl. G06F 17/60

(52) U.S. Cl. 705/39

(57) ABSTRACT

A computer-based method and system to enable managing access to payroll data for employees. The payroll data includes an employee-identifier for each of the employees, and data relating to periodic compensation payments made by the employer. The system stores the payroll data, receives employee user request for payroll information, selects payroll data for the employee based upon predetermined criteria, and displays payroll information for the employee based upon predetermined criteria, including whether the employee has enrolled in the employer's direct deposit payroll program, or whether the employee's request for payroll data is submitted within the employer's predetermined introductory period for the employee. The invention is compatible with network communications such as the Internet/intranet, cellular systems and high bandwidth digital communications so that employees may be able to access the system from remote locations to receive payroll data and direct deposit account data and execute changes to their direct deposit account data via the Internet worldwide.

### TECHNICAL FIELD

This invention relates to computer software applications used to collect and disseminate employee payroll information. The invention facilitates the integration of employee payroll information with payroll direct deposit election information so that users can access and implement changes to both employee payroll and direct deposit election information via a network.

### BACKGROUND ART

In recent years employers have been computerizing many of their employee payroll activities, in some cases including the electronic provision of payroll information to employees, thus allowing faster and more efficient dissemination of payroll data than with conventional paper paychecks and paper pay statements. Employers have also recognized the benefits of providing compensation to employees through electronic funds transfer (direct deposit) to employees' bank accounts. Direct deposit programs provide employees with advantages of speed, flexibility, security in managing and allocating their earnings, while at the same time providing employers with a more efficient and less expensive means of payroll administration. In many cases, however employees are reluctant to transition from the conventional paper paycheck system to a direct deposit payroll program. To increase efficiency and reduce costs, employers need a means to educate and motivate employees to enroll in direct deposit payroll programs.

### SUMMARY OF THE INVENTION

The present invention provides a new and unique process for, among other things, preferably enabling employees to access payroll data and perform a variety of payroll functions using a computer, telephone, or other communications network that enables the transfer of digital computer information. The present invention allows employers to avoid spending valuable time processing routine employee payroll information requests, because employees are able to receive important payroll information, such as a duplicate Form W-2 or a prior pay statement, without ever having to go through their company payroll department. Internet users can print payroll information reports, while telephone users can have payroll information reports voiced faxed to them.

Accordingly, the present invention is directed to a communications network-based computer software application used to collect and disseminate payroll information to employees, to demonstrate the benefits of direct deposit to the employees, and to provide incentive for employees to enroll in direct deposit payroll programs. The invention preferably facilitates the integration of disseminating employee payroll information with direct deposit participation by allowing employees to access their payroll information electronically during a specified introductory time period. Upon expiration of the introductory period, the employee may only access such information upon participation in the employer's direct deposit payroll program. The invention preferably further facilitates participation in direct deposit payroll programs by informing employees of the benefits of enrolling in direct deposit payroll programs and by tracking and reminding employees of the time remaining in the introductory period to accomplish such participation. The invention also can be used to allow participating direct deposit employees to access services related to W-2 and W-4 processing, as well as automated and/or on-line employment and income verification services for use by the employee in securing credit arrangements with third parties, for example, financial institutions.

The invention may also be used to facilitate the integration of disseminating employee payroll and direct deposit information with W-4 program participation by allowing employees to access their payroll and/or direct deposit information electronically during a specified introductory time period, and thereafter only upon participation in the employer's W-4 program.

Features and advantages of the invention will be set forth in the description which follows, and in part will be apparent from the description, or may be learned by practice of the invention. Other advantages of the invention will be realized and attained by the method and apparatus particularly pointed out in the written description and claims thereof, as well as in the appended drawings.

To achieve the objects of this invention and attain its advantages, broadly speaking, this invention is directed to a method and system for managing payroll data and direct deposit accounts for a plurality of employees, wherein the payroll data may include:

employee name

SSN

employee ID

department

base pay rate

marital tax status

federal, state, and local tax exemptions

primary and secondary state code

locality codes

paycheck date

paycheck number or pay statement number

pay period begin date

pay period end date

pay frequency

current and year-to-date earnings amounts

earnings rate

earnings shift rate

earnings hours

current and year-to-date gross pay

current and year-to-date pre-tax deductions

total pre-tax deductions

current and year-to-date tax deductions

total current and year-to-date tax deductions

current and year-to-date after-tax deductions

total current and year-to-date after-tax deductions

current taxable wages

current net pay

amounts of current pay deposited to direct deposit account(s)

non-deduction type benefits, such as vacation accrued, vacation taken, 401(k) employer match, and company stock.

The direct deposit account data may include the following information for at least one financial institution account established by the participating employee:

direct deposit account type

direct deposit account description (from database)

direct deposit allocation amount or percentage

financial institution account number

financial institution Routing Transit Number (RTN).

The system integrates the payroll data and the direct deposit data by matching the direct deposit participation data for each employee with the employee-identifier, and based upon the employee's eligibility for access to payroll information, generates a payroll report according to the request input by the employee. This report can be delivered by various means, including but not limited to, e-mail, fax, or visual display on employee output device, such as computer monitor or PDA monitor

The present invention also has the capability to record when a user accesses the direct deposit data and details any change the user has made to the direct deposit election data for implementation by the employer or automatically by the system.

Broadly, in one aspect, the present invention concerns a method for transmitting payroll data and direct deposit payroll information for a plurality of employees over a network comprising: maintaining a computer system that is capable of sending and receiving data over the network; storing employee identification data, payroll data, and direct deposit data corresponding to each employee, and criteria for determining direct deposit payroll participation in the computer system; inputting in the computer system data corresponding to a time interval for each employee, during which interval following the reference date, if the direct deposit data for the employee does not satisfy the criteria for direct deposit payroll participation, the employee may receive payroll data; receiving over the network employee identification data from an employee; matching the received employee identification data to the corresponding payroll data and direct deposit data in the computer system; determining whether the direct deposit data for the employee satisfies the criteria for direct deposit payroll participation; and if the employee direct deposit data satisfies the criteria, sending the corresponding payroll data over the network to the employee; and if not, determining whether the employee time interval following the employee reference date has expired, and if the time interval has not expired, sending the corresponding payroll data over the network to the employee.

It is to be understood that both the foregoing general description and the following detailed description are exemplary and explanatory and are intended to provide further explanation of the invention as claimed.

### BRIEF DESCRIPTION OF THE DRAWINGS

The accompanying drawings which are incorporated in and which constitute part of this specification, illustrate a presently preferred implementation of the invention and, together with the description, serve to explain the principles of the invention.

FIG. 1 is a block diagram of the system of a preferred implementation of the present invention; and

FIG. 2 is a flow chart diagram of the method of a preferred implementation of the present invention.

### DETAILED DESCRIPTION OF THE PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

Data Input

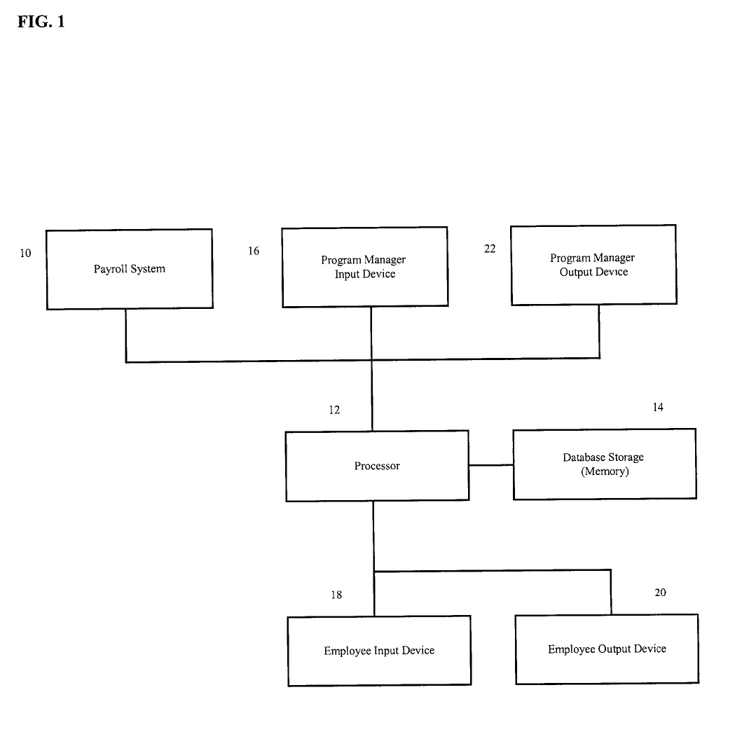

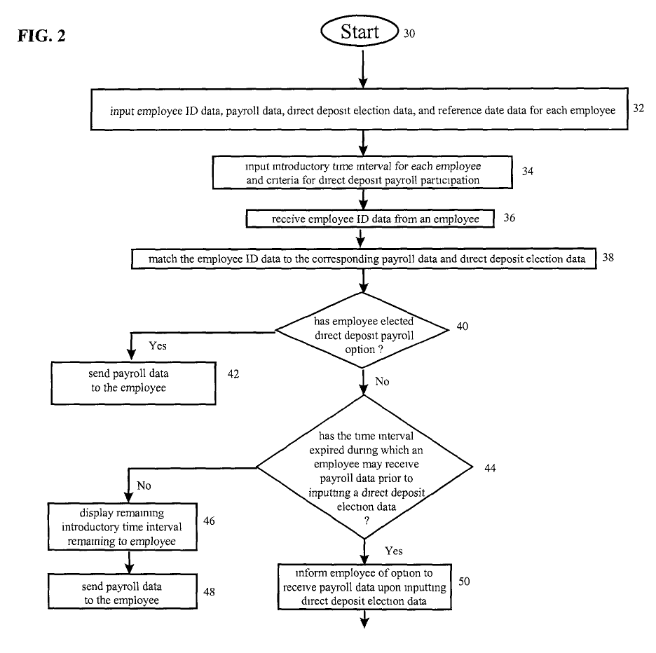

Referring now to FIG. 1, FIG. 1 outlines the components of the system of a preferred embodiment of the present invention. Payroll data relating to the employer's employees is extracted from the employer's payroll system 10 and transmitted via Internet/intranet, cellular systems, high bandwidth digital communications, Electronic Data Interchange (EDI) or other network communications means utilizing File Transfer Protocol (FTP) or Frame Relay, or such as through diskette, magnetic tape or CD ROM to the processor 12 of the system computer for loading to the database storage (memory). If the transferred data is compressed using PKZip or other data compression software, the data is uncompressed and loaded into the system. Also, if the transferred data has been encrypted using PGP or other encryption software, the data is decrypted and loaded into the system.

This invention may be practiced using Extensible Markup Language (XML) interface technology well known to those skilled in the art. In the alternative, it may also be practiced by the process of HTML, downloading Java Script Code. In yet another way, the invention may be practiced by down loading Active X code to the users. Both Java Script and Active X are well known to those skilled in the art and are within the scope of this invention.

Computer Processor

The computer processor 12 controls the storage and retrieval of the payroll data, including the employees' direct deposit election data, in the database storage (memory) 14 of the system computer. Processor 12 also controls the receipt and transmission of data from the database storage 14 of the system computer to and from the employee input device 18, the employee output device 20, the program manager input device 16, and the program manager output device 22.

Input of Employer's Options

Pre-determined introductory time-intervals and reference dates for each employee are input through the program manager input device 16. This information may be transmitted via Internet/intranet, cellular systems, high bandwidth digital communications or Electronic Data Interchange (EDI) or other network communications, including means utilizing File Transfer Protocol (FTP), or such as through diskette, magnetic tape or CD ROM to the system computer processor 12 and stored in the system computer memory 14. The introductory time interval may be uniformly established for all employees, individually assigned for each employee, or alternatively, may be pre-determined according to the employee's work group, pay group or job classification, or derived by formula or rule based upon one or more criteria including the employee's hire date, length of service, time of eligibility for direct deposit participation, or other payroll related criteria.

Input of Employee's Request for Payroll Information

The employee input device 18 may comprise any type of input device which may be used by the employee for the input of employee identification data and requests for payroll information, as well as for input of and corrections to employee elections for participation in an employer's direct deposit program. These input devices may include, for example, keyboard, keypad, graphical user interface (“GUI”), Internet access, e-mail, voice recognition program, telephone, cellular telephone, pager, PDA, or other voice or data input device, including, for example, scanning information from a source document. This input may take place over Internet/intranet, cellular systems, high bandwidth digital communications, Electronic Data Interchange (EDI) or other network communications, including means utilizing HTTP, HTTPS, or File Transfer Protocol (FTP).

Output To Employee

Once the employee's request or other information or instructions are input into the processor 12 of the computer system, the appropriate response or information may be conveyed to the employee through employee output device 20. This output device 20 may comprise any of a variety of output media including, for example, printed document, artificial or human voice, personal electronic communication device, such as computer terminal, laptop computer, PDA, pager, cell phone, computer monitor, GUI, Internet, e-mail, CDROM, cellular telephone display, PDA display, printout, facsimile, or other method of image, data, or document transmission.

The payroll information report provided to the employee may include those items normally provided in a paper pay statement, and at the employer's and/or employee's option, may comprise the following payroll data:

“current as of” date (date of last data update or employer pay date)

employer name

employee Name

SSN

employee ID

department

employment status (active, inactive, retired, etc.)

employee's most recent start date,

total time in years and months the employee has been employed by the employer,

current job title

average hours worked per pay period,

employee's year-to-date pay information,

previous year's income information (broken down into the following categories: base pay, overtime pay, bonus, commissions, other pay, and total pay),

next projected date of pay increase

last date of pay increase,

next projected amount of pay increase,

last amount of pay increase,

on leave start date

on leave stop date

base pay rate

marital tax status

federal, state, and local tax exemptions

primary and secondary state code

locality codes

paycheck date

paycheck number or pay statement number

pay period begin date

pay period end date

pay frequency

current and year-to-date earnings amounts

earnings rate

earnings shift rate

earnings hours

current and year-to-date gross pay

current and year-to-date pre-tax deductions

total pre-tax deductions

current and year-to-date tax deductions

total current and year-to-date tax deductions

current and year-to-date after-tax deductions

total current and year-to-date after-tax deductions

current taxable wages

current net pay

amounts of current pay deposited to direct deposit account(s)

direct deposit account type

direct deposit account description (from database)

direct deposit allocation amount or percentage

financial institution account number

financial institution Routing Transit Number (RTN)

non-deduction type benefits, such as vacation accrued, vacation taken, 401(k) employer match, and company stock.

Output To Program Manager

Similarly any instructions, reports or information generated by the system may be transmitted to the program manager output device 22, which may comprise one or more of a variety of output device media including, for example, computer monitor, GUI, Internet, e-mail, CDROM, cellular telephone display, PDA display, printout, facsimile, or other method of image, data or document transmission.

Input of Employee Data and Employer Elections

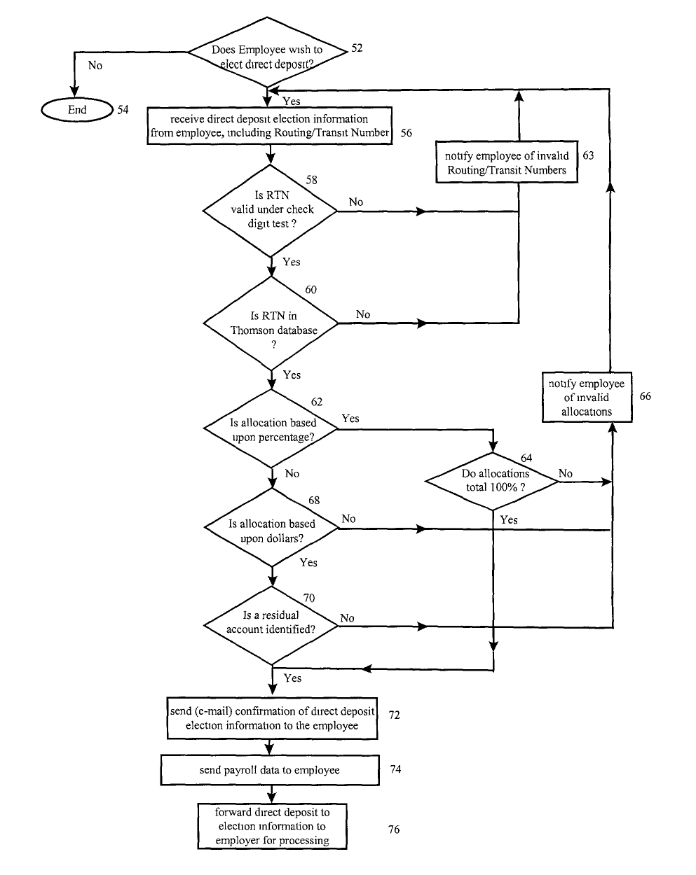

Turning now to FIG. 2, FIG. 2 is a flow chart illustrating the method of one embodiment of the present invention. Upon initiation of the program in Step 32, employee identification data, payroll data and direct deposit election data relating to the employee, along with reference date data for each employee, are input into the computer of the system. In Step 34 a predetermined introductory time interval for each employee, and criteria for direct deposit payroll participation are input. The introductory time interval may be individually determined for each employee, globally established as a uniform time interval for all employees, or assigned to employees, based upon their job classifications, pay classifications, and/or work assignments. The employer may define qualifying participation in a direct deposit program according to various criteria, for example, whether some or all of the employee's pay is deposited in one or more accounts established for the employee. As explained more fully below, if desired, an employee may allocate portions of periodic pay into one or more accounts by dollar amount or percentage, and may optionally request a conventional paper paycheck for the remaining balance amounts or a designated fixed amount. An employer may determine that qualifying participation in the direct deposit program would require all of an employee's pay to be allocated to one or more direct deposit accounts, thereby precluding employees receiving paper paycheck from qualifying in the direct deposit program; or an employer may determine that qualifying participation in the direct deposit program means a portion of an employee's pay may be delivered in the form of a paper check as long as at least one direct deposit account is also set up.

Input and Qualification of Employee Request

After an employee enters identification data (Step 36) from an employee input device, the system matches the employee identification data to the corresponding payroll data for that employee, including data relating to direct deposit elections made by the employee if any, at Step 38. At Step 40 the system determines whether the direct deposit election data for the employee satisfies the employer's requirement for participation in the direct deposit program, using the criteria for direct deposit payroll participation input in Step 34. This determination can be made by evaluating whether at least one direct deposit account number and the associated financial institution's Routing Transit Number (RTN) have been input by the employee to identify an account to which at least a portion of the employee's periodic pay is to be deposited. Stored value card accounts, such as accounts which can be accessed by ATM cards, cash cards, salary cards, gift cards, debit cards, or payroll cards, may also be included in the permitted direct deposit accounts.

Output of Requested Data

If the direct deposit election information relating to the employee is determined to be sufficient to qualify for access to payroll information according to the employer's criteria, the payroll information requested by the employee is sent over the Internet, e-mail, CDROM, cellular telephone display, PDA display, printout, facsimile, or other selected method of image, data or document transmission to the employee in Step 42. The composition and format of the data may be predetermined by the employer, and thus, no input by the employee beyond identification information may be necessary. Alternatively, the employee may request specific composition and/of format of the data, or may select from a number of predetermined report formats.

If the direct deposit election data relating to the employee is not sufficient according to the employer's criteria, at Step 44 the introductory time interval for the employee is added to the employee's reference date to determine whether the introductory time period has expired for the employee's access to payroll information.

Reminder to Employee of Participation Option

If the introductory time period has not expired, the employee will be notified by the output means of the time remaining in the employee's introductory time period (after which the employee will need to enroll in direct deposit in order to have access to payroll information) at Step 46, and the payroll information requested by the employee is sent at Step 48. The remaining time period ma be conveyed in numerals, text and/or graphically, such as in an illustration of a countdown clock or progression bar. Alternatively, if the introductory time period has expired, in Step 50 the employee will be notified that the time period has expired and reminded that the employee may be permitted to access the payroll information upon completion of the procedures necessary for participation in the direct deposit program, including the provision of an RTN and account number for deposit of the employee's pay. This information may be conveyed to the employee over the employee output device.

Employee Participation

After the participation information is displayed to the employee, the employee is given the immediate option to elect direct deposit at Step 52. If the employee responds negatively or fails to respond, the program terminates at Step 54 with the display of an appropriate status message to the employee.

If the employee responds affirmatively, at Step 56, the employee will be requested to submit information in response to prompts for identification of at least one direct deposit account. This information will include: the account type, for example, checking account, savings account, or stored value card; account number; RTN for the financial institution; and the employee's description of the account and/or account purpose, for example, Christmas club account, retirement account or vacation account. The direct deposit election information also includes the employee's allocation of pay into one or more accounts, either in terms of percentages of pay or fixed dollar amounts into different accounts, with an identified account for the remaining balance of the pay.

RTN Validation

In Step 58 the RTN input by the employee is tested for validation using the check digit routine, also called Modulus 10 Straight Summation. Using this method, a precalculated check digit is provided as the final digit of the RTN, for example, 7 in the RTN 067813457. The formula for calculating the check digit for RTN 067813457 is as follows:

$$\begin{matrix}first 8 digits of RTN \text{:} & 0 & 6 & 7 & 8 & 0 & 3 & 4 & 5\end{matrix}$$

$$\begin{matrix}multiply by \text{:} & \underline{\begin{matrix}3 & 7 & 1 & 3 & 7 & 1 & 3 & 7\end{matrix}}\end{matrix}$$

$$results \qquad 0 \qquad 42 \qquad 7 \qquad 24 \qquad 0 \qquad 3 \qquad 12 \qquad 35$$

$$sum of results \qquad = 123$$

The check digit for the sum is determined by adding the number that takes the sum to the next highest number ending in zero. In this case for 123, 123+7=130, so 7 is the check digit. This check digit routine can be performed on the system processor, or if appropriate, on the employee's input device.

If the check digit test is valid, in Step 60 the RTN input by the employee is cross-checked with the Thomson database for validity. The system searches for the RTN in the Thomson Financial Publishing's Routing and Transit Number (RTN) Database, which lists all U.S. financial institutions and their assigned RTNs. Thomson Financial Publishing is the Official RTN Registrar used by the American Banking Association.

Notifying Employee of Erroneous Data

If the submitted RTN fails either test, in Step 63 the employee receives a notification on the employee output device indicating that the submitted RTN is invalid, along with a request for review and correction of the submitted RTN. The notification may include instructions for the employee to contact the identified bank to verify the RTN. Following this notification, the employee is again prompted to submit corrected RTN information in Step 56. Also, after a predetermined number of failed attempts to enter a valid RTN, the system can provide additional remedial instructions to the employee. For example, if the employee has already contacted the bank, the employee may be instructed to call a toll-free phone number to speak with a system administrator.

Employee Input of Data

If the RTN is valid, the corresponding bank name is displayed, and the Account Number prompt appears. After the account number is entered, the Account Description prompt appears. The employee may optionally enter a description of the account (such as “Family Checking Account”). This description cannot be the same as a previously entered Direct Deposit description for that employee. The RTN, account number, and account type combination must not be the same as an existing Direct Deposit entry for that employee.

The employee then continues to add other accounts, or if the final account has been input, a list of all of the Direct Deposit accounts that were entered, including each Description, Bank Name, RTN, Account Number, Type of Account, and the allocation information are displayed to enable the employee to make any corrections to the data before saving to the database.

Allocation Check

If the employee has submitted information for all direct deposit accounts and all the RTNs submitted by the employee are valid, an allocation check is performed in Steps 62, 64, 68 and 70. In Step 62, if the employee has established “Allocation” in percent, then in Step 64, the sum of the percent allocations for the accounts must equal 100 percent. If this test is passed, the program continues at Step 72. If not, the employee is informed of the invalid allocation instructions at Step 66 and given an opportunity to correct them at Step 56.

If allocations based upon percentage have not been identified in Step 62, the program proceeds to step 68 for a determination of whether the allocation is based upon fixed dollar amounts. If not, since neither a percentage nor a dollar allocation is indicated, the employee is informed of the invalid allocation data at Step 66 and given an opportunity for correction at Step 56. In Step 68, if “Allocation” is in dollars, then in Step 70, the designation of a residual account is examined. The residual account is designated to receive the leftover pay amounts in excess of the fixed dollar amounts allocated to the other accounts. If such residual account is indicated, the program continues at Step 72. If not, the employee is informed of the invalid allocation data at Step 66 and given an opportunity for correction at Step 56.

Confirmation of Data

If the allocations submitted by the employee are valid, the employee executes “Save,” the system will write the information to the database, and a Confirmation Page will be displayed. At Step 72 the employee is provided with an e-mail confirmation of the direct deposit election information for the employee's records.

The email may be sent to the employee confirming any instruction to add/delete/change to the employee's direct deposit account(s). The email address may be entered by the employee or received in from the payroll information file. If there is no employee email address in the payroll information file or is not entered by the employee, an email may be sent to the employer's payroll department.

The text for this email may be altered to suit the needs and preferences of the employer. An example email format is as follows:

To: <First Name><Last Name>

From: <Employer Name>

Subject: Change to Direct Deposit

Your Direct Deposit Account Setup was changed on mm/dd/ccyy at hh:mm by <you or your Payroll Manager>. You may review your current Direct Deposit Distributions by accessing the system on the web or by calling toll free 1-xxx-xxx-xxxx.

Next, at Step 74, the requested payroll information is transmitted to the employee. Alternatively, the employer may require that the actual implementation of the direct deposit payment be accomplished before the employee is granted access to payroll information.

Transmittal of Data Modifications to Program Manager

Finally, the modifications to an employee's direct deposit data are stored in the system database. At Step 76, a file will be created and transmitted to the program manager containing all of the Direct Deposit records for any employee that made an addition or change to Direct Deposit data since the previous transmission. Such transmissions may be initiated periodically or upon receipt of updates from an employee. This data file may be manually input or automatically uploaded in the employer's payroll system. At the time of the transmission, a Change Hold may be placed on the employee's Direct Deposit records. This status allows the employee or the program manager to only view the records and not make any changes. After the program manager has processed the Direct Deposit data modifications, the system will then remove the Change Hold and allow subsequent changes to be made to the employee's Direct Deposit data records.

Direct Deposit Data Updates

Once employees have enrolled in the Direct Deposit program, they may review existing direct deposit accounts with the option to add, modify, or delete accounts anytime via communications networks including the company Intranet, corporate portal, telephone, public Internet, or a private network connection (VPN, Frame Relay, etc.).

W-2 Information Management

The employee's qualification for access to payroll information may also include access to W-2 information and services, including distributing printed and electronic original W-2 statements, reissuing W-2 statements via the Internet or telephone, and facilitating corrections and the distribution of W-2c statements. Duplicate W-2s, if requested, can be immediately delivered to employees via Web printout, fax or mail. Employees may initiate W-2 corrections, for which the system posts detailed information, such as a report on a secure website for the employer to review and approve or deny an employee's request for a W-2 correction. The employer may then forward a file of corrections to the appropriate program manager for processing.

W-4 Information Management

The employee's qualification for access to payroll information may also include access to W-4 Information Management. Using this feature, employees can easily setup and update their federal W-4 withholding information. In a Web environment, employees complete an electronic form that looks like the IRS Form W-4. Telephone users complete the same form by responding to verbal questions using their telephone keypad. In addition to federal withholdings, the system provides employees with online access to their state's equivalent Form W-4.

Alternatively, the employee's input of W-4 data may also be used as qualification criteria for the employee's access to payroll information. The required data may include allowances (for dependents), marital status, Social Security Number (SSN), additional withholding amount, and exemption status.

Employment Information Verification Services

The employee's qualification for access to payroll information may also include access to Employment and Income Verification Services. Using this feature, the employee contacts the service provider and obtains at least one salary key code (SKC), if required. The SKC gives the verifier authority to verify income information for a single transaction and thus enhances security in the system regarding release of employee income information.

The employee then discloses at least one SKC to the verifier over the Internet, orally over the telephone, or in a face-to-face meeting. The verifier contacts the system web site and enters appropriate identification data and the SKC, if required. The identification data and the SKC are compared against a list of valid SKCs and identification data in the system database. If the SKC is valid and the other identification data is valid, the system will generate a report to the verifier containing employment and/or income information. This report may be sent to the verifier over the Internet, preferably in encrypted form.

Alternatively, this system can be used to verify, within predetermined parameters, the income information contained in an application which has been completed by an employee. The verifier contacts the system web site and enters appropriate identification data and the income information previously provided by the employee. Then the system either confirms or denies the accuracy of the income data to the verifier, without disclosing the exact amount of the employee's income.

Personal Information Manager

The employee's qualification for access to payroll information may also include access to Personal Information Manager. Using this feature, employees can quickly and easily update their personal information files in the employer's database via communications networks including the Internet, intranet, or corporate portal. The personal information may include: full name, home address and telephone number, work address and telephone number, email address, date of birth, marital status, emergency contacts, and additional specified personal data fields.

Employee Login

When the system URL is entered, the main selection screen, (home page) is displayed to the employee. When the employee selects the employee login function the connection between the employee and the system is encrypted using Secure Socket Layer (SSL). This technology is native to web browser software and well known to those skilled in the art. Other types of encryption methods known to those skilled in the art are within the scope of this invention. If the system supports more than one employer, the employee selects the employer identification via a drop down menu, and enters their SSN, and their personal identification number (PIN). The system then compares the employee PIN entered to the PIN stored on the primary database. If the company, SSN and PIN match the data in the database, the employee is validated and allowed access.

Employee Login Lock-Out

During the employee login process an employee may make up to three attempts to a login. If for whatever reason, i.e., mis-typed, forgotten PIN, etc., login is not achieved, the system displays a message screen that the login attempt was unsuccessful and the employee may make another attempt. If after three attempts the employee has not successfully logged in, the system displays a message screen telling the employee that their access to the system has been curtailed for a period of thirty minutes. The web application writes a lock out record for this employee to the primary database.

Upon the next attempt to login, the system compares the date and time stamps on any lock out records for the employee to the system date and time. If at least thirty minutes have passed since the lock out record was written, the employee may again attempt to log into the system. If at least thirty minutes have not passed the system displays lock out message screen. This lock out feature enhances employee security by preventing long periods of login attempts for the purpose of trying unlimited combinations of identification information, either manually or via a software program, to discover valid combinations of employee identification information and surreptitiously gain system access.

Employee Display

If an employee has previously established Direct Deposit distributions, the distributions are displayed as originally set up. An existing distribution can be changed by clicking on the “Change” button, deleted by clicking on the “Delete” button, or the Deposit Order can be adjusted by clicking on the “Up” or “Down” button. The system can be configured to determine if the employee is allowed to delete the last Direct Deposit account. The employee can also add a new account or paper check if allowed by the employer and if the maximum number of accounts specified for the system has not been exceeded.

If an employee has not previously set up Direct Deposit distributions, the first page will display the Setup Instructions. The employee then proceeds through a number of pages to setup the account(s). The first page prompts for the number of accounts to be setup. Next is the Allocation Type prompt (% or $) if the employer allows allocations both by dollars and percents. The response to this prompt determines if the next page is either the amount prompt or the percent prompt where the employee must designate the allocation amount for the first account. After clicking “Next”, the prompt for the Account Type appears. Account Types may be specified in a drop down list. The “Paper Check” option is displayed only if specified by the employer and the employee has not already specified a Paper Check. Only one Paper Check is allowed per employee. When the “Paper Check” option is selected, the prompts for RTN, Account Number, and Account Description are bypassed.

Employee Message Section

The employee display may also include an Employee Message Section providing up to five messages for each pay date. These can be enterprise-wide messages or employee-specific messages. These messages are plain text and may contain HTML links.

While preferred embodiments of the invention and preferred methods of practicing the same have been shown and described herein, persons of ordinary skill in the art will recognize and appreciate that the invention encompasses and includes numerous modifications and variations thereto without departing from the spirit and scope of the present invention. In addition, it should be understood, and persons of ordinary skill in the art will recognize, that aspects of the various preferred embodiments discussed herein may be interchanged or eliminated both in whole or in part. Furthermore, those of ordinary skill in the art will appreciate the foregoing description is by way of example only, and does not and is not intended to limit the scope, nature and/or variations of the invention.

What is claimed is:

1. A method for using a computer apparatus for managing access to payroll data and direct deposit data for a plurality of employees over a network, the method comprising:
maintaining a computer system that is capable of sending and receiving data over the network;
storing in the computer system employee identification data, payroll data, and direct deposit data corresponding to each employee, and criteria for direct deposit payroll participation;
receiving over the network employee identification data from an employee;
matching the received employee identification data to the corresponding payroll data and direct deposit data in the computer system;
determining whether the direct deposit data for the employee satisfies the criteria for direct deposit payroll participation; and
if the employee direct deposit data satisfies the criteria, sending the corresponding payroll data over the network to the employee.

2. The method of claim 1 wherein the computer system is capable of receiving direct deposit data from the employees over the network.

3. The method of claim 2 further comprising the step of providing the employee confirmation of the direct deposit data received from the employee.

4. The method of claim 2 wherein the direct deposit data received from the employees comprises RTNs.

5. The method of claim 4 further comprising the step of identifying invalid RTNs in the direct deposit data from the employees and notifying the employee.

6. The method of claim 2 wherein the criteria for direct deposit payroll participation may be input.

7. The method of claim 6 wherein the criteria may be input by an employer of the employee.

8. The method of claim 2 wherein the direct deposit data received from the employee comprises a description generated by the employee for each direct deposit account.

9. The method of claim 8 wherein the payroll data sent over the network to the employee comprises the description generated by the employee for each direct deposit account.

10. The method of claim 2 further comprising the step of storing in the computer system W-2 data corresponding to each employee, and wherein if the employee direct deposit data satisfies the criteria, the employee is provided access to the W-2 data corresponding to the employee.

11. The method of claim 2 further comprising the step of storing in the computer system W-4 data corresponding to each employee, and wherein if the employee direct deposit data satisfies the criteria, the employee is provided access to the W-4 data corresponding to the employee.

12. The method of claim 2 wherein if the employee direct deposit data satisfies the criteria, the employee is provided access to income verification services.

13. A method for using a computer apparatus for managing access to payroll data and direct deposit data for a plurality of employees over a network, the method comprising:
maintaining a computer system that is capable of sending and receiving data over the network;
storing in the computer system employee identification data, payroll data, direct deposit data, and reference date data corresponding to each employee, and criteria for direct deposit payroll participation;
inputting in the computer system data corresponding to a time interval for each employee, during which interval following the reference date, if the direct deposit data for the employee does not satisfy the criteria for direct deposit payroll participation, the employee may receive payroll data;
receiving over the network employee identification data from an employee;
matching the received employee identification data to the corresponding payroll data and direct deposit data in the computer system;
determining whether the direct deposit data for the employee satisfies the criteria for direct deposit payroll participation;
if the employee direct deposit data satisfies the criteria, sending the corresponding payroll data over the network to the employee; and
if the employee direct deposit data does not satisfy the criteria, determining whether the employee time interval following the employee reference date has expired, and if the time interval has not expired, sending the corresponding payroll data over the network to the employee.

14. The method of claim 13 wherein the computer system is capable of receiving direct deposit data from the employees over the network.

15. The method of claim 14 further comprising the step of providing the employee confirmation of the direct deposit data received from the employee.

16. The method of claim 14 wherein the direct deposit data received from the employees comprises RTNs.

17. The method of claim 16 further comprising the step of identifying invalid RTNs in the direct deposit data from the employees and notifying the employee.

18. The method of claim 13 wherein the criteria for direct deposit payroll participation may be input.

19. The method of claim 18 wherein the criteria may be input by an employer of the employee.

20. The method of claim 13 wherein the direct deposit data received from the employee comprises a description generated by the employee for each direct deposit account.

21. The method of claim 20 wherein the payroll data sent over the network to the employee comprises the description generated by the employee for each direct deposit account.

22. The method of claim 13 wherein if the employee direct deposit data does not satisfy the criteria and the time interval has not expired, the remaining time interval is displayed to the employee.

23. The method of claim 13 wherein the direct deposit data comprise an option for pay distribution to a stored value card.

24. The method of claim 13 wherein the corresponding payroll data is displayed in fields and the data comprises hyperlinks to definitions associated with one or more of the fields.

25. The method of claim 13 further comprising the step of storing in the computer system W-2 data corresponding to each employee, and wherein if the employee direct deposit data satisfies the criteria, the employee is provided access to the W-2 data corresponding to the employee.

26. The method of claim 13 further comprising the step of storing in the computer system W-4 data corresponding to each employee, and wherein if the employee direct deposit data satisfies the criteria, the employee is provided access to the W-4 data corresponding to the employee.

27. The method of claim 13 wherein if the employee direct deposit data satisfies the criteria, the employee is provided access to income verification services.

28. A method for using a computer apparatus for managing access to payroll data and W-4 data for a plurality of employees over a network, the method comprising:
maintaining a computer system that is capable of sending and receiving data over the network;
storing in the computer system employee identification data, payroll data, and W-4 data corresponding to each employee, and criteria for W-4 participation;
receiving over the network employee identification data from an employee;
matching the received employee identification data to the corresponding payroll data and W-4 data in the computer system;
determining whether the W-4 data for the employee satisfies the criteria for W-4 participation;
if the employee W-4 data satisfies the criteria, sending the corresponding payroll data over the network to the employee.

29. The method of claim 28 wherein the computer system is capable of receiving W-4 data from the employees over the network.

30. The method of claim 29 further comprising the step of providing the employee confirmation of the W-4 data received from the employee.

31. The method of claim 28 wherein the criteria for direct deposit payroll participation may be input.

32. The method of claim 31 wherein the criteria may be input by an employer of the employee.

33. The method of claim 28 further comprising the step of storing in the computer system W-2 data corresponding to each employee, and wherein if the employee W-4 data satisfies the criteria, the employee is provided access to the W-2 data corresponding to the employee.

34. The method of claim 28 wherein if the employee W-4 data satisfies the criteria, the employee is provided access to income verification services.

35. A computer based system for managing access to payroll data and direct deposit data for a plurality of employees over a network, the system comprising:
an input device for receiving input data,
a processor connected to the input device which is programmed to store input data in a memory device and to perform operations upon stored data to produce output data,
a memory device connected to the processor for storing the input data, and
an output device connected to the processor for displaying the output data;
the input device capable of receiving payroll data and direct deposit data for a plurality of employees, criteria for direct deposit payroll participation, and a request for payroll data from one of the employees over the network; and
the processor programmed for determining whether the employee direct deposit data satisfies the criteria and if the employee direct deposit data satisfies the criteria, sending the corresponding payroll data over the network to the employee.

36. The system of claim 35 wherein data corresponding to a time interval and a reference date for each employee may be input, and wherein the processor is programmed for determining whether the employee time interval following the employee reference date has expired, and if not, sending the corresponding payroll data over the network to the employee.

37. The system of claim 36 wherein the input device is capable of receiving data representing the employee's direct deposit election.
